(19) United States
(12) Patent Application Publication
(10) Pub. No.: US 2025/0338384 A1
(43) Pub. Date: Oct. 30, 2025

(54) MICROWAVE PLASMA TORCH EQUIPMENT AND USE THEREOF IN MANUFACTURING GRAPHENE NANOPARTICLES, AND NANOFLUID COMPOSITION AND MANUFACTURING METHOD THEREOF

(71) Applicant: INDUSTRIAL TECHNOLOGY RESEARCH INSTITUTE, Hsinchu (TW)

(72) Inventors: Ya-Chi HO, New Taipei City (TW); Tsai-Liang WU, Zhubei City (TW); Cheng-Hsuan LIN, Hsinchu City (TW); Chih-Ming HO, Los Angeles, CA (US); Da-Jeng YAO, Taipei City (TW)

(73) Assignee: INDUSTRIAL TECHNOLOGY RESEARCH INSTITUTE, Hsinchu (TW)

(21) Appl. No.: 18/962,352

(22) Filed: Nov. 27, 2024

Related U.S. Application Data
(60) Provisional application No. 63/638,844, filed on Apr. 25, 2024.

(51) Int. Cl. H05H 1/30; B82Y 40/00; C01B 32/184; C01B 32/194

(52) U.S. Cl. CPC H05H 1/30; B82Y 40/00; C01B 32/184; C01B 32/194; C01P 2004/64; H05H 2242/24; H05H 2245/50

(57) ABSTRACT

A microwave plasma torch equipment includes a reaction chamber, a ventilation tube and a microwave source. The reaction chamber has a reaction area, a microwave inlet, a first divert channel, a second divert channel and a microwave diverter. Each of the first and second divert channels has first and second end parts. The first end parts are coupled to the microwave inlet. The second end parts are coupled to each other at the reaction area. The cross-sectional areas of the first end parts are greater than those of the second end parts. The microwave diverter is located at the junction of the microwave inlet and the first and second divert channels. The ventilation tube penetrates through the reaction area along a direction substantially perpendicular to the extending direction of the first and second divert channels. The microwave source is located at the microwave inlet and facing the microwave diverter.

### CROSS-REFERENCE TO RELATED APPLICATIONS

All related applications are incorporated by reference. The present application is based on, and claims priority from, U.S. Provisional Application Ser. No. 63/638,844 filed on Apr. 25, 2024, the disclosure of which is hereby incorporated by reference herein in its entirety.

### BACKGROUND

### 1. Technical Field

The disclosure relates to a microwave plasma torch equipment and use thereof in manufacturing graphene nanoparticles, a nanofluid composition, and a manufacturing method thereof.

### 2. Related Art

There are many types of graphene, including graphene sheets, graphene oxide, reduced graphene oxide, nitrogen-doped graphene, graphene quantum dots, etc. Graphene has excellent lateral thermal conductivity, allowing heat to rapidly diffuse from the heat source to areas farther away, and achieving effective heat dissipation. Current technologies have developed graphene fluids and applied them as working fluids in heat pipes for heat dissipation and cooling applications.

However, it is known that graphene fluids often exhibit good heat dissipation performance in the early stages of use, and, as usage time increases, graphene tends to aggregate and precipitate in the working fluid, leading to a deterioration in heat dissipation performance over time. Therefore, developing graphene nanofluids, in which graphene nanoparticles remain stably suspended in the working fluid, to improve the decline in heat dissipation and cooling performance over time has become an important challenge.

### SUMMARY

An embodiment of the disclosure provides a microwave plasma torch equipment, including a reaction chamber, a ventilation tube and a microwave source. The reaction chamber has a reaction area, a microwave inlet, a first divert channel, a second divert channel and a microwave diverter. Each of the first divert channel and the second divert channel has a first end part and a second end part away from the first end part. Both of the first end parts are coupled to the microwave inlet. The second end parts are coupled to each other at the reaction area. The cross-sectional areas of the first end parts are greater than the cross-sectional areas of the second end parts. The microwave diverter is located at the junction of the microwave inlet, the first divert channel, and the second divert channel. The ventilation tube penetrates through the reaction area of the reaction chamber along a direction substantially perpendicular to the extending direction of the first divert channel and the extending direction of the second divert channel. The microwave source is located at the microwave inlet and facing the microwave diverter.

An embodiment of the disclosure also provides a method for manufacturing graphene nanoparticles with a microwave plasma torch equipment, including: injecting an alkane gas and an inert gas into the microwave plasma torch equipment; and heating the alkane gas from opposite sides of the alkane gas by two microwave plasmas propagating in opposite directions to obtain graphene nanoparticles.

An embodiment of the disclosure also provides a nanofluid composition, including a solvent, graphene nanoparticles and a surfactant. The weight ratio of the graphene nanoparticles to the solvent is 1:100000 to 1:20. The weight ratio of the surfactant to the graphene nanoparticles is 0.3:1 to 5:1.

An embodiment of the disclosure also provides a manufacturing method of nanofluid composition, including: adding the graphene nanoparticles and a surfactant into a solvent to form a mixture; and stirring the mixture to make the graphene nanoparticles disperse uniformly in the solvent to form the nanofluid composition. The weight ratio of the graphene nanoparticles to the solvent is 1:100000 to 1:20, and the weight ratio of the surfactant to the graphene nanoparticles is 0.3:1 to 5:1.

### BRIEF DESCRIPTION OF THE DRAWINGS

FIG. 1 is a schematic diagram of a microwave plasma torch equipment of an embodiment of the disclosure.

FIG. 2 is a schematic diagram of a reaction chamber of a microwave plasma torch equipment of an embodiment of the disclosure.

FIG. 3 is a cross-sectional view of the reaction chamber of the microwave plasma torch equipment of FIG. 2.

FIG. 4 is a simulated energy distribution diagram of a cross-section of the reaction chamber of the microwave plasma torch equipment of FIG. 2.

FIG. 5 is a simulated energy distribution diagram of another cross-section of the reaction chamber of the microwave plasma torch equipment of FIG. 2.

FIG. 6 is a simulated energy distribution diagram of a reaction chamber of a conventional microwave plasma torch equipment.

FIG. 7 is a system block diagram including a microwave plasma torch equipment of an embodiment of the disclosure.

FIG. 8 is a flow chart for manufacturing a nanofluid composition according to an embodiment of the disclosure.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

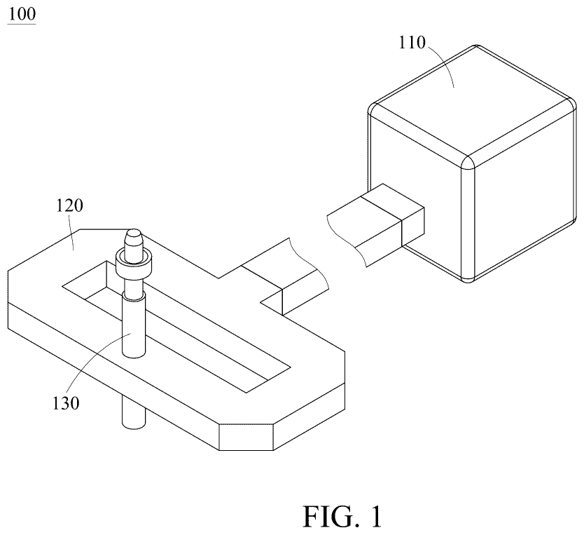

Hereafter, a microwave plasma torch equipment of an embodiment of the disclosure will be described in detail with reference to FIG. 1 to FIG. 5.

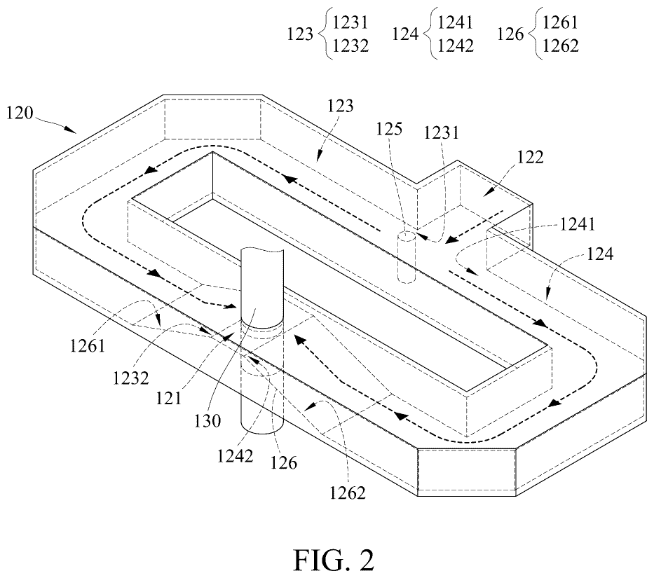

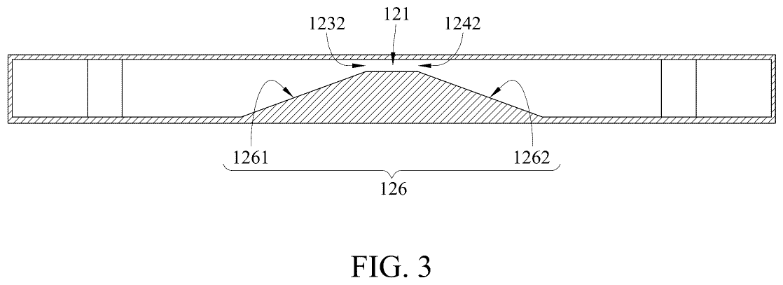

FIG. 1 is a schematic diagram of a microwave plasma torch equipment of an embodiment of the disclosure, FIG. 2 is a schematic diagram of a reaction chamber of a microwave plasma torch equipment of an embodiment of the disclosure, and FIG. 3 is a cross-sectional view of the reaction chamber of the microwave plasma torch equipment FIG. 2.

Referring to FIG. 1, a microwave plasma torch equipment 100 of an embodiment of the disclosure includes a microwave source 110, a reaction chamber 120 and a ventilation tube 130. The microwave source 110 may emit microwaves with a frequency ranging from 2.40 GHz to 2.50 GHz and a power ranging from 500 watts to 3000 watts. In an embodiment, the microwave source 110 may emit microwaves with a frequency of 2.45 GHz and a power of 1200 watts. The reaction chamber 120 may be made of copper, aluminum, stainless steel or iron. The ventilation tube 130 penetrates through a portion of the reaction chamber 120, allowing the microwaves introduced into the reaction chamber 120 from the microwave source 110 to heat the gas inside the ventilation tube 130 to perform a reaction. A material of the ventilation tube 130 may include quartz or other dielectric material that allows microwaves to pass therethrough. In an embodiment of the disclosure, the ventilation tube 130 may be a quartz tube. The gas in the ventilation tube 130 is, for example, a mixed gas including nitrogen, argon, and methane. In addition, a device, such as isolator, coupler, or triple probe may optionally be further installed between the microwave source 110 and the reaction chamber 120.

Referring to FIG. 2, the reaction chamber 120 has a reaction area 121, a microwave inlet 122, a first divert channel 123, a second divert channel 124, and a microwave diverter 125.

The reaction area 121 is penetrated by the ventilation tube 130. The first divert channel 123 and the second divert channel 124 are coupled to the microwave inlet 122 and converge oppositely at the reaction area 121. In detail, the first divert channel 123 has a first end part 1231 and a second end part 1232 disposed at opposite ends of the first divert channel 123. The cross-sectional area of the first end part 1231 is greater than the cross-sectional area of the second end part 1232. The second divert channel 124 has a first end part 1241 and a second end part 1242 disposed at opposite ends of the second divert channel 124. The cross-sectional area of the first end part 1241 is greater than the cross-sectional area of the second end part 1242. The first end part 1231 of the first divert channel 123 and the first end part 1241 of the second divert channel 124 are coupled to the microwave inlet 122. The second end part 1232 of the first divert channel 123 and the second end part 1242 of the second divert channel 124 are coupled to the reaction area 121. Specifically, the first end parts 1231 and 1241 are communicated with the microwave inlet 122, and the second end parts 1232 and 1242 are communicated with each other at the reaction area 121. The microwave diverter 125 is disposed at a junction of the microwave inlet 122, the first divert channel 123, and the second divert channel 124, and may have a shape of cylindrical, hexagonal, etc. In an embodiment of the disclosure, the microwave diverter 125 has a shape of cylindrical. Microwaves introduced into the microwave inlet 122 from the microwave source 110 are guided by the microwave diverter 125. A portion of microwaves travels to the reaction area from the first end part 1231 of the first divert channel 123 through the second end part 1232, and the other portion of microwaves travels to the reaction area from the first end part 1241 of the second divert channel 124 through the second end part 1242.

Referring to FIG. 3, in an embodiment of the disclosure, the microwave plasma torch equipment of the disclosure may further include a microwave guide 126. The microwave guide 126 has a first guiding surface 1261 and a second guiding surface 1262. The first guiding surface 1261 is a portion of the second end part 1232 of the first divert channel 123, and the second guiding surface 1262 is a portion of the second end part 1242 of the second divert channel 124. In an embodiment, the cross-sectional areas of the second end parts 1232 and 1242 are greater than or equal to the cross-sectional area of the reaction area 121.

When microwaves are introduced into the reaction chamber 120 from the microwave inlet 122, microwaves may be diverted to the first divert channel 123 and the second divert channel 124 due to the microwave diverter 125. Microwaves propagating through the first divert channel 123 and the second divert channel 124 will then propagate in opposite directions to the reaction area 121, respectively, and be focused, thereby applying energy from opposite sides to the gas in the ventilation tube 130 penetrating through the reaction area 121, and forming a high-temperature plasma environment in the region of the quartz tube corresponding to the reaction area, such that the alkanes is cracked to produce graphene. In addition, due to the reduction of the cross-sectional area, the microwaves propagating through the first divert channel 123 and the second divert channel 124 are further concentrated in the reaction area, thereby increasing the temperature and uniformity of the plasma and increasing the cracking rate.

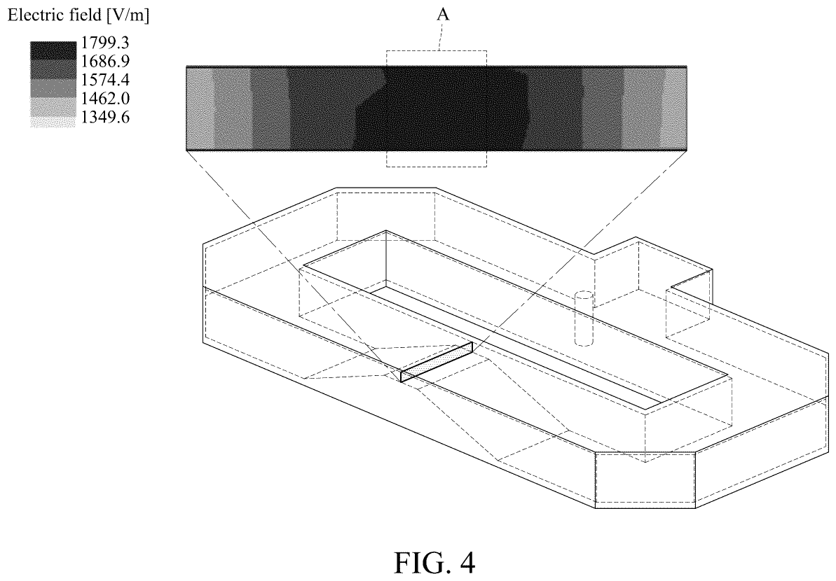

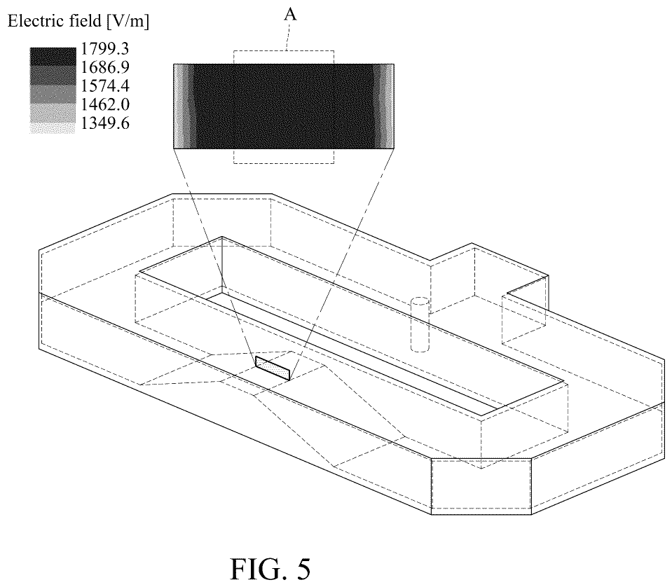

FIG. 4 is a simulated energy distribution diagram of a cross-section of the reaction chamber of the microwave plasma torch equipment of FIG. 2, and FIG. 5 is a simulated energy distribution diagram of another cross-section of the reaction chamber of the microwave plasma torch equipment of FIG. 2.

As shown in FIG. 4 and FIG. 5, it can be seen that the energy distribution in the region (region A) of the reaction chamber of the microwave plasma torch equipment of an embodiment of the disclosure corresponding to the quartz tube penetrating the reaction area exhibits a symmetric distribution, by two microwave plasmas propagating from opposite directions and concentrated in the reaction area. Furthermore, in the simulated energy distribution diagram, the region corresponding to the quartz tube shows uniform color with almost no visible color difference, indicating that the energy uniformity in the region corresponding to the quartz tube is greater than or equal to 90%. Such energy uniformity facilitates the manufacturing of graphene nanoparticles with small and uniform sizes.

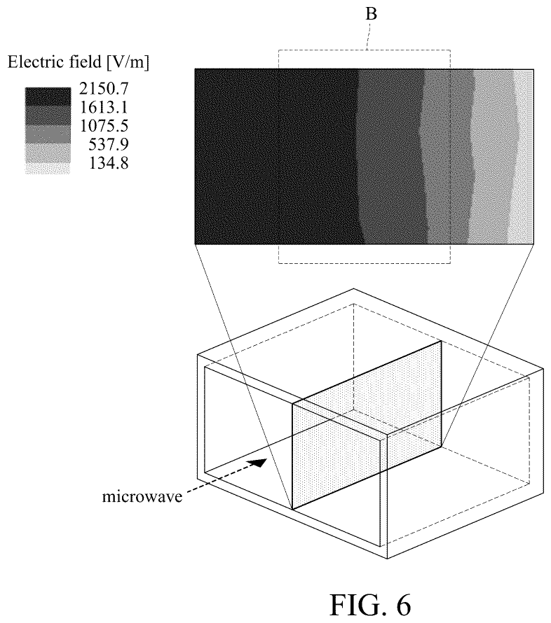

FIG. 6 is a simulated energy distribution diagram of a reaction chamber of a conventional microwave plasma torch equipment. On the contrary, referring to FIG. 6, the conventional microwave plasma torch equipment concentrates microwaves in the reaction area only from single direction. The energy distribution in the region (region B) of the reaction chamber of the microwave plasma torch equipment corresponding to the quartz tube penetrating the reaction area is significantly asymmetric, and the energy uniformity thereof is only about 50%. In this way, the size uniformity of graphene nanoparticles made by microwave plasma torch equipment that concentrates microwaves in single direction is significantly lower than the size uniformity of graphene nanoparticles made by the microwave plasma torch equipment of the disclosure.

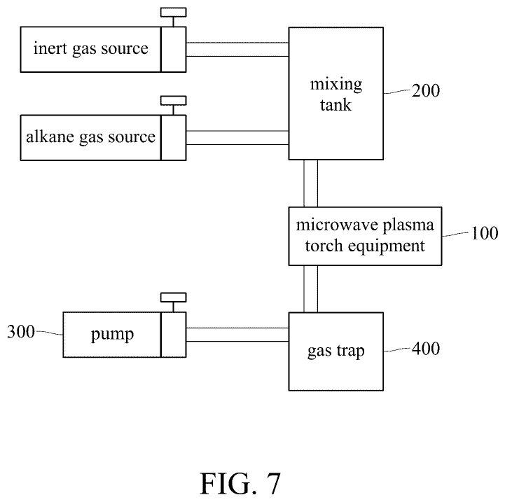

Hereafter, a method for manufacturing graphene nanoparticles with the microwave plasma torch equipment of the disclosure will be described in detail with reference to FIG. 7.

FIG. 7 is a system block diagram including a microwave plasma torch equipment of an embodiment of the disclosure.

In an embodiment of the disclosure, the method for manufacturing graphene nanoparticles with a microwave plasma torch equipment includes: injecting an alkane gas and an inert gas into the microwave plasma torch equipment; and heating the alkane gas from opposite sides of the alkane gas by two microwave plasmas propagating in opposite directions to obtain graphene nanoparticles.

In detail, the alkane gas and the inert gas are injected into a mixing tank 200 and mixed uniformly, the mixed gas is then injected into a microwave plasma torch equipment 100, and in the present of inert gas, the alkane gas is decomposed into carbon and hydrogen due to the high-temperature plasma environment generated by the microwave plasma torch equipment. The generated carbon atoms deposit and form graphene nanoparticles. A pump 300 is connected to one end of the microwave plasma torch equipment 100 and may pump out unreacted gases and decomposed byproduct gases (such as hydrogen) in the microwave plasma torch equipment. A gas trap 400 may be further disposed between the pump 300 and the microwave plasma torch equipment 100 to effectively filter the gases extracted by the pump 300, thereby protecting the pump 300 and extending its service life. In addition, the gas trap 400 may also capture specific gases (such as hydrogen or unreacted alkane gas) for subsequent utilization. In an embodiment of the disclosure, the mixing tank 200 and the pump 300 are coupled to both ends of the ventilation tube the microwave plasma torch equipment 100.

In an embodiment of the disclosure, the alkane gas includes, but not limited to, methane, ethane, propane, or a combination thereof. The microwaves provided by the microwave source 110 of the microwave plasma torch equipment 100 generates microwave plasma torch at the junction of the microwave source 110, the inert gas, and the alkane gas, so that the alkane gas cracks and a graphene is formed. In an embodiment of the disclosure, the alkane gas is methane to avoid complex by products or impurities, thereby facilitating the production of high-purity graphene. In an embodiment of the disclosure, the purity of graphene produced by the method for manufacturing graphene nanoparticles with a microwave plasma torch equipment reaches 99.999%.

In an embodiment of the disclosure, the inert gas includes, but not limited to, nitrogen, helium, argon, or a combination thereof. Due to stable chemical properties of the inert gas, the inert gas may avoid unnecessary chemical reactions with other substances during plasma reaction. The inert gas ionizated under microwave irradiation to form high-temperature plasma. Since the inert gas itself does not participate in the reaction, it can provide a more stable and controllable plasma environment, which is suitable for the manufacture of high-purity materials. In an embodiment of the disclosure, the inert gas is argon.

In an embodiment of the disclosure, the frequency of the microwaves emitted by the microwave source 110 of the microwave plasma torch equipment 100 may be 2.40 GHz to 2.50 GHz, and the power of the microwaves emitted by the microwave source 110 may be 500 watts to 3000 watts. When the power of the microwaves is too high, the temperature of the plasma is increased, causing the decomposed carbon atoms to form graphite or uneven graphene. When the power of the microwaves is too low, the alkane gas is not effectively decomposed to form graphene nanoparticles. In an embodiment of the disclosure, the frequency of the microwaves emitted by the microwave source 110 may be 2.45±0.05 GHZ, and the power of the microwaves emitted by the microwave source 110 may be 3000 watts.

In an embodiment of the disclosure, the nanofluid composition includes a solvent, graphene nanoparticles and a surfactant, wherein the weight ratio of the graphene nanoparticles to the solvent is 1:100000 to 1:20, and the weight ratio of the surfactant to the graphene nanoparticles is 0.3:1 to 5:1.

In an embodiment of the disclosure, the solvent includes, but not limited to, water, methanol, ethanol, acetone, or synthetic oil. The nanofluid composition using water, methanol, ethanol, acetone as a solvent is suitable to be applied to various heat pipes, such as capillary heat pipes, flat heat pipes, gravity heat pipes, or oscillating heat pipes. The nanofluid composition using synthetic oil as a solvent is suitable to be applied to refrigeration and air conditioning systems, such as home air conditioners, refrigerators, and freezers.

The surfactant of the disclosure may be any of various known surfactants. The selection of the surfactant depends on its own hydrophilic-lipophilic balance (HLB) and the solvent to which it is applied. The higher the HLB of the surfactant, the more hydrophilic (water soluble) the surfactant is; contrarily, the lower the HLB of the surfactant, the more lipophilic (oil-soluble) the surfactant is. For example, when the HLB of the surfactant is greater than or equal to 10, the surfactant is suitable to be applied to water; alternatively, when the HLB of the surfactant is less than 10, the surfactant is suitable to be applied to oil. However, when the solvent is organic solvent, such as methanol, ethanol, and acetone, the selection of the surfactant is not limited by the HLB. In an embodiment of the disclosure, the surfactant includes, but not limited to, SDS, SDBS, Tween20-80, Span20-80, CTAB, TTAB or a combination thereof.

In an embodiment, when the solvent is water, the weight ratio of the surfactant to the graphene nanoparticle may be 2:1 to 5:1. In an embodiment, when the solvent is synthetic oil, the weight ratio of the surfactant to the graphene nanoparticle may be 1:3 to 1:1. In an embodiment, when the solvent is methanol, ethanol, or acetone, the weight ratio of the surfactant to the graphene nanoparticle may be 1:1 to 4:1.

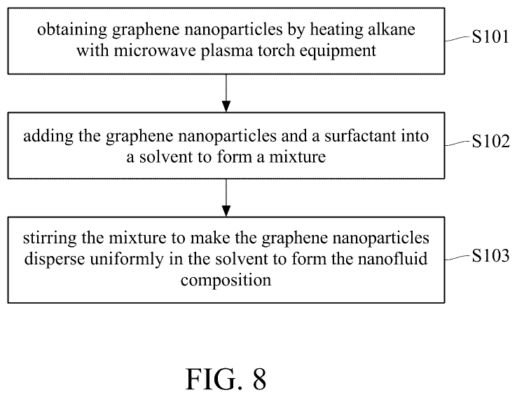

Hereafter, a manufacturing method of a nanofluid composition of an embodiment of the disclosure will be described in detail with reference to FIG. 8.

FIG. 8 is a flow chart for manufacturing a nanofluid composition according to an embodiment of the disclosure.

In an embodiment of the disclosure, the manufacturing method of a nanofluid composition includes: obtaining graphene nanoparticles by heating alkane with microwave plasma torch equipment (step S101); adding the graphene nanoparticles and a surfactant into a solvent to form a mixture (step S102); and stirring the mixture to make the graphene nanoparticles disperse uniformly in the solvent to form the nanofluid composition (step S103).

First, alkane is heated by a microwave plasma torch equipment to obtain graphene nanoparticles (step S101). In detail, the graphene nanoparticles may be manufactured by the microwave plasma torch equipment of an embodiment of the disclosure and the method for manufacturing graphene nanoparticles using the same. In the embodiment, the graphene nanoparticles manufactured by the method of manufacturing graphene nanoparticles above is used in subsequent steps to manufacture the nanofluid composition, but the disclosure is not limited thereto. In other embodiments of the disclosure, the graphene nanoparticles manufactured by other methods may be used in subsequent steps to manufacture the nanofluid composition.

Then, the graphene nanoparticles and the surfactant are added into a solvent to form a mixture (step S102). In detail, the graphene nanoparticles, the surfactant and the solvent are mixed to form the mixture where a weight ratio of the graphene nanoparticles to the solvent is 1:100000 to 1:20 and a weight ratio of the surfactant to the graphene nanoparticles is 0.3:1 to 5:1.

Then, the mixture is stirred to make the graphene nanoparticles disperse uniformly in the solvent to form the nanofluid composition (step S103). In detail, the graphene nanoparticles and the surfactant are primarily dispersed in the solvent by a stir bar and an electromagnetic stirrer. Then, the mixture including the graphene nanoparticles and the surfactant is placed into an ultrasonic oscillator for ultrasonic oscillation, so that the surfactant effectively coats the graphene and disperses, thereby obtaining a uniformly dispersed graphene nanofluid composition. In an embodiment of the disclosure, the duration for ultrasonic oscillation is preferably 15 minutes to 45 minutes, allowing the surfactant to effectively coat the graphene and disperse while avoiding damage to the single-layer or multi-layer structure of the graphene caused by ultrasonic oscillation. In an embodiment of the disclosure, the duration for ultrasonic oscillation is 30 minutes. In an embodiment of the disclosure, the step of stirring the mixture to make the graphene nanoparticles disperse uniformly in the solvent is performed by an ultrasonic oscillator, but not limited thereto. In other embodiments of the disclosure, the step of stirring the mixture to make the graphene nanoparticles disperse uniformly in the solvent may be performed by an electromagnetic stirrer.

In capillary heat pipes or flat heat pipes, when SDS is used as the surfactant and the solvent is water, the weight ratio of the graphene nanoparticles to the solvent is 1:100000 to 1:100, and the weight ratio of the surfactant to the graphene nanoparticles is 1:1 to 2:1. At this time, the improvement ratio of the maximum amount of thermal conduction is 15% to 42% and the improvement ratio of the thermal conductivity coefficient is 10% to 22%. When SDS is used as the surfactant and the solvent is organic solvent, such as methanol, ethanol, and acetone, the weight ratio of the graphene nanoparticles to the solvent is 1:100000 to 1:100 and the weight ratio of the surfactant to the graphene nanoparticles is 1:1 to 4:1. At this time, the improvement ratio of the maximum amount of thermal conduction is 15% to 42% and the improvement ratio of the thermal conductivity coefficient is 10% to 22%. In gravity heat pipes or oscillating heat pipes, when SDS is used as the surfactant and the solvent is water, the weight ratio of the graphene nanoparticles to the solvent is 1:100000 to 1:40 and the weight ratio of the surfactant to the graphene nanoparticles is 1:1 to 3:1. At this time, the improvement ratio of the maximum amount of thermal conduction is 35% to 125% and the improvement ratio of the thermal conductivity coefficient is 55% to 700%. When SDS is used as the surfactant and the solvent is organic solvent, such as methanol, ethanol, and acetone, the weight ratio of the graphene nanoparticles to the solvent is 1:100000 to 1:40 and the weight ratio of the surfactant to the graphene nanoparticles is 1:1 to 4:1. At this time, the improvement ratio of the maximum amount of thermal conduction is 10% to 50% and the improvement ratio of the thermal conductivity coefficient is 20% to 80%.

In refrigeration and air conditioning systems, when SDBS is used as the surfactant and the solvent is synthetic oil, the weight ratio of the graphene nanoparticles to the solvent is 1:10000 to 1:20 and the weight ratio of the surfactant to the graphene nanoparticles is 0.3:1 to 1:1. At this time, the improvement ratio of the maximum amount of thermal conduction is 2.2%. In capillary heat pipes or flat heat pipes, when SDBS is used as the surfactant and the solvent is water, the weight ratio of the graphene nanoparticles to the solvent is 1:100000 to 1:100 and the weight ratio of the surfactant to the graphene nanoparticles is 1:1 to 5:1. At this time, the improvement ratio of the maximum amount of thermal conduction is 15% to 42% and the improvement ratio of the thermal conductivity coefficient is 10% to 22%. When SDBS is used as the surfactant and the solvent is organic solvent, such as methanol, ethanol, and acetone, the weight ratio of the graphene nanoparticles to the solvent is 1:100000 to 1:100 and the weight ratio of the surfactant to the graphene nanoparticles is 1:1 to 3:1. At this time, the improvement ratio of the maximum amount of thermal conduction is 15% to 42% and the improvement ratio of the thermal conductivity coefficient is 10% to 22%. In gravity heat pipes or oscillating heat pipes, when SDBS is used as the surfactant and the solvent is water, the weight ratio of the graphene nanoparticles to the solvent is 1:100000 to 1:40 and the weight ratio of the surfactant to the graphene nanoparticles is 1:1 to 5:1. At this time, the improvement ratio of the maximum amount of thermal conduction is 35% to 125% and the improvement ratio of the thermal conductivity coefficient is 55% to 700%. When SDBS is used as the surfactant and the solvent is organic solvent, such as methanol, ethanol, and acetone, the weight ratio of the graphene nanoparticles to the solvent is 1:100000 to 1:40 and the weight ratio of the surfactant to the graphene nanoparticles is 1:1 to 3:1. At this time, the improvement ratio of the maximum amount of thermal conduction is 10% to 50% and the improvement ratio of the thermal conductivity coefficient is 20% to 80%.

In refrigeration and air conditioning systems, when Tween 20-80 is used as the surfactant and the solvent is synthetic oil, the weight ratio of the graphene nanoparticles to the solvent is 1:10000 to 1:20 and the weight ratio of the surfactant to the graphene nanoparticles is 0.5:1 to 1:1. At this time, the improvement ratio of the maximum amount of thermal conduction is 2.2%. In capillary heat pipes or flat heat pipes, when Tween 20-80 is used as the surfactant and the solvent is water, the weight ratio of the graphene nanoparticles to the solvent is 1:100000 to 1:100 and the weight ratio of the surfactant to the graphene nanoparticles is 1:1 to 2:1. At this time, the improvement ratio of the maximum amount of thermal conduction is 15% to 42% and the improvement ratio of the thermal conductivity coefficient is 10% to 22%. When Tween 20-80 is used as the surfactant and the solvent is organic solvent, such as methanol, ethanol, and acetone, the weight ratio of the graphene nanoparticles to the solvent is 1:100000 to 1:100 and the weight ratio of the surfactant to the graphene nanoparticles is 1:1 to 4:1. At this time, the improvement ratio of the maximum amount of thermal conduction is 15% to 42% and the improvement ratio of the thermal conductivity coefficient is 10% to 22%. In gravity heat pipes or oscillating heat pipes, when Tween 20-80 is used as the surfactant and the solvent is water, the weight ratio of the graphene nanoparticles to the solvent is 1:100000 to 1:40 and the weight ratio of the surfactant to the graphene nanoparticles is 1:1 to 3:1. At this time, the improvement ratio of the maximum amount of thermal conduction is 35% to 125% and the improvement ratio of the thermal conductivity coefficient is 55% to 700%. When Tween 20-80 is used as the surfactant and the solvent is organic solvent, such as methanol, ethanol, and acetone, the weight ratio of the graphene nanoparticles to the solvent is 1:100000 to 1:40 and the weight ratio of the surfactant to the graphene nanoparticles is 1:1 to 4:1. At this time, the improvement ratio of the maximum amount of thermal conduction is 10% to 50% and the improvement ratio of the thermal conductivity coefficient is 20% to 80%.

In refrigeration and air conditioning systems, when Span 20-80 is used as the surfactant and the solvent is synthetic oil, the weight ratio of the graphene nanoparticles to the solvent is 1:10000 to 1:20 and the weight ratio of the surfactant to the graphene nanoparticles is 0.5:1 to 1:1. At this time, the improvement ratio of the maximum amount of thermal conduction is 2.2%. In capillary heat pipes or flat heat pipes, when Span 20-80 is used as the surfactant and the solvent is water, the weight ratio of the graphene nanoparticles to the solvent is 1:100000 to 1:100 and the weight ratio of the surfactant to the graphene nanoparticles is 1:1 to 2:1. At this time, the improvement ratio of the maximum amount of thermal conduction is 15% to 42% and the improvement ratio of the thermal conductivity coefficient is 10% to 22%. When Span 20-80 is used as the surfactant and the solvent is organic solvent, such as methanol, ethanol, and acetone, the weight ratio of the graphene nanoparticles to the solvent is 1:100000 to 1:100 and the weight ratio of the surfactant to the graphene nanoparticles is 1:1 to 4:1. At this time, the improvement ratio of the maximum amount of thermal conduction is 15% to 42% and the improvement ratio of the thermal conductivity coefficient is 10% to 22%. In gravity heat pipes or oscillating heat pipes, when Span 20-80 is used as the surfactant and the solvent is water, the weight ratio of the graphene nanoparticles to the solvent is 1:100000 to 1:40 and the weight ratio of the surfactant to the graphene nanoparticles is 1:1 to 3:1. At this time, the improvement ratio of the maximum amount of thermal conduction is 35% to 125% and the improvement ratio of the thermal conductivity coefficient is 55% to 700%. When Span 20-80 is used as the surfactant and the solvent is organic solvent, such as methanol, ethanol, and acetone, the weight ratio of the graphene nanoparticles to the solvent is 1:100000 to 1:40 and the weight ratio of the surfactant to the graphene nanoparticles is 1:1 to 4:1. At this time, the improvement ratio of the maximum amount of thermal conduction is 10% to 50% and the improvement ratio of the thermal conductivity coefficient is 20% to 80%.

In refrigeration and air conditioning systems, when CTAB is used as the surfactant and the solvent is synthetic oil, the weight ratio of the graphene nanoparticles to the solvent is 1:10000 to 1:20 and the weight ratio of the surfactant to the graphene nanoparticles is 0.5:1 to 1:1. At this time, the improvement ratio of the maximum amount of thermal conduction is 2.2%. In capillary heat pipes or flat heat pipes, when CTAB is used as the surfactant and the solvent is water, the weight ratio of the graphene nanoparticles to the solvent is 1:100000 to 1:100 and the weight ratio of the surfactant to the graphene nanoparticles is 1:1 to 3:1. At this time, the improvement ratio of the maximum amount of thermal conduction is 15% to 42% and the improvement ratio of the thermal conductivity coefficient is 10% to 22%. When CTAB is used as the surfactant and the solvent is organic solvent, such as methanol, ethanol, and acetone, the weight ratio of the graphene nanoparticles to the solvent is 1:100000 to 1:100 and the weight ratio of the surfactant to the graphene nanoparticles is 1:1 to 2:1. At this time, the improvement ratio of the maximum amount of thermal conduction is 15% to 42% and the improvement ratio of the thermal conductivity coefficient is 10% to 22%. In gravity heat pipes or oscillating heat pipes, when CTAB is used as the surfactant and the solvent is water, the weight ratio of the graphene nanoparticles to the solvent is 1:100000 to 1:40 and the weight ratio of the surfactant to the graphene nanoparticles is 1:1 to 3:1. At this time, the improvement ratio of the maximum amount of thermal conduction is 35% to 125% and the improvement ratio of the thermal conductivity coefficient is 55% to 700%. When CTAB is used as the surfactant and the solvent is organic solvent, such as methanol, ethanol, and acetone, the weight ratio of the graphene nanoparticles to the solvent is 1:100000 to 1:40 and the weight ratio of the surfactant to the graphene nanoparticles is 1:1 to 2:1. At this time, the improvement ratio of the maximum amount of thermal conduction is 10% to 50% and the improvement ratio of the thermal conductivity coefficient is 20% to 80%.

In refrigeration and air conditioning systems, when TTAB is used as the surfactant and the solvent is synthetic oil, the weight ratio of the graphene nanoparticles to the solvent is 1:10000 to 1:20 and the weight ratio of the surfactant to the graphene nanoparticles is 0.3:1 to 1:1. At this time, the improvement ratio of the maximum amount of thermal conduction is 2.2%. In capillary heat pipes or flat heat pipes, when TTAB is used as the surfactant and the solvent is water, the weight ratio of the graphene nanoparticles to the solvent is 1:100000 to 1:100 and the weight ratio of the surfactant to the graphene nanoparticles is 1:1 to 2:1. At this time, the improvement ratio of the maximum amount of thermal conduction is 15% to 42% and the improvement ratio of the thermal conductivity coefficient is 10% to 22%. When TTAB is used as the surfactant and the solvent is organic solvent, such as methanol, ethanol, and acetone, the weight ratio of the graphene nanoparticles to the solvent is 1:100000 to 1:100 and the weight ratio of the surfactant to the graphene nanoparticles is 1:1 to 2:1. At this time, the improvement ratio of the maximum amount of thermal conduction is 15% to 42% and the improvement ratio of the thermal conductivity coefficient is 10% to 22%. In gravity heat pipes or oscillating heat pipes, when TTAB is used as the surfactant and the solvent is water, the weight ratio of the graphene nanoparticles to the solvent is 1:100000 to 1:40 and the weight ratio of the surfactant to the graphene nanoparticles is 1:1 to 3:1. At this time, the improvement ratio of the maximum amount of thermal conduction is 35% to 125% and the improvement ratio of the thermal conductivity coefficient is 55% to 700%. When TTAB is used as the surfactant and the solvent is organic solvent, such as methanol, ethanol, and acetone, the weight ratio of the graphene nanoparticles to the solvent is 1:100000 to 1:40 and the weight ratio of the surfactant to the graphene nanoparticles is 1:1 to 2:1. At this time, the improvement ratio of the maximum amount of thermal conduction is 10% to 50% and the improvement ratio of the thermal conductivity coefficient is 20% to 80%.

The refrigeration and air conditioning systems include home air conditioners, refrigerators, freezers, etc. The capillary heat pipes include grooved heat pipes, sintered heat pipes, mesh heat pipes, composite capillary heat pipes, and the flat heat pipes include vapor chamber. The oscillating heat pipes include pulsating heat pipes, pulsed heat pipes, etc. The improvement ratio of the maximum amount of thermal conduction of 2.2% is calculated by using COP (Coefficient of Performance), where COP=Q/W. Here, Q represents the useful heat supplied to (or extracted from) the system, and W represents the mechanical work required from an external source by the system.

### EXAMPLE

### Manufacture Example 1

Argon and methane are mixed and injected into a microwave plasma torch equipment at a flow rate of 0.5 L/min to 1.0 L/min. The argon and the methane in the quartz tube are heated by a microwave source with a frequency of 2.45±0.05 GHz and a power of 3000 watts to form a microwave plasma torch, thereby cracking the methane to form high-purity (purity greater than 99.999%) graphene nanoparticles.

### Manufacture Example 2

According to the composition and amounts listed in Table 1, the graphene nanoparticles formed in the manufacture example 1 and a surfactant are added into a solvent to form a mixture, and are stirred for at least 15 minutes by a stir bar and an electromagnetic stirrer to make the graphene nanoparticles and the surfactant primarily disperse in the solvent. Then, the mixture including the graphene nanoparticles and the surfactant is place into an ultrasonic oscillator for ultrasonic oscillation for at least 15 minutes to obtain a uniformly dispersed graphene nanofluid composition.

Graphene nanofluid compositions of each example of the disclosure are manufactured according to manufacture example 2 with the amounts listed in Table 1, and the improvement ratio of the maximum amount of thermal conduction and the improvement ratio of the thermal conductivity coefficient thereof are measured. The improvement ratio of the maximum amount of thermal conduction is a ratio of the maximum amount of thermal conduction graphene nanofluid composition to that of pure water in a closed heat pipe (the maximum amount of thermal conduction of graphene nanofluid composition/the maximum amount of thermal conduction of pure water). The improvement ratio of the thermal conductivity coefficient is a ratio of the thermal conductivity coefficient of graphene nanofluid composition to that of pure water in a closed heat pipe (the thermal conductivity coefficient of graphene nanofluid composition/the thermal conductivity coefficient of pure water).

TABLE 1

| | | | | | | | | | Improvement | Improvement |
|---|---|---|---|---|---|---|---|---|---|---|
| | | Weight ratio | | | | | | | ratio of the | ratio of the |
| | | of graphene | | | | | | | maximum | thermal |
| | | nano- | Weight ratio of surfactant to graphene | | | | | | amount of | |
| | | particles | nanoparticles (wt %/wt %) | | | | | | thermal | conductivity |
| | | to solvent | | | Tween | Span | | | conduction | coefficient |
| | Solvent | (wt %) | SDS | SDBS | 20-80 | 20-80 | CTAB | TTAB | (%) | (%) |
| Example | Synthetic | 0.001 | — | — | — | — | — | 0.3 | 0.2% | — |
| 1-1 | oil | | | | | | | | | |
| Example | Synthetic | 0.01 | — | — | — | — | 0.5 | — | 0.8% | — |
| 1-2 | oil | | | | | | | | | |
| Example | Synthetic | 0.1 | — | — | 1 | — | — | — | 0.5% | — |
| 1-3 | oil | | | | | | | | | |
| Example | Synthetic | 0.25 | — | — | 1 | — | — | — | 2.2% | — |
| 1-4-1 | oil | | | | | | | | | |
| Example | Synthetic | 0.25 | | | | 0.5 | | | 1.4 | |
| 1-4-2 | oil | | | | | | | | | |
| Example | Synthetic | 0.25 | | 0.5 | | | | | 1.6 | — |
| 1-4-3 | oil | | | | | | | | | |
| Example | Synthetic | 0.5 | — | 0.5 | | — | — | — | 1.8% | — |
| 1-5-1 | oil | | | | | | | | | |
| Example | Synthetic | 0.5 | — | 1 | | — | — | — | 0.7% | — |
| 1-5-2 | oil | | | | | | | | | |
| Example | Synthetic | 1.0 | | | | | | | 0.2% | — |
| 1-6 | oil | | | | | | | | | |
| Example | Water | 0.001 | — | — | 2 | — | — | — | 0.5% | 2.0% |
| 2-1 | | | | | | | | | | |
| Example | Water | 0.01 | — | — | 2 | — | — | — | 1.0% | 2.5% |
| 2-2 | | | | | | | | | | |
| Example | Water | 0.1 | — | — | 2 | — | — | — | 32% | 10% |
| 2-3 | | | | | | | | | | |
| Example | Water | 0.25 | — | — | 2 | — | — | — | 42% | 20% |
| 2-4-1 | | | | | | | | | | |
| Example | Water | 0.25 | — | — | — | 2 | — | — | 20% | 8.0% |
| 2-4-2 | | | | | | | | | | |
| Example | Water | 0.25 | — | — | — | — | 2 | — | 15% | 6.0% |
| 2-4-3 | | | | | | | | | | |
| Example | Water | 0.25 | — | — | — | — | — | 1 | 20% | 5.0% |
| 2-4-4 | | | | | | | | | | |
| Example | Water | 0.5 | — | 5 | — | — | — | — | 7.5% | 1.6% |
| 2-5 | | | | | | | | | | |
| Example | Water | 1.0 | 1 | — | — | — | — | — | 4.0% | 0.8% |
| 2-6-1 | | | | | | | | | | |
| Example | Water | 1.0 | — | — | 2 | — | — | — | 5.0% | 0.5% |
| 2-6-2 | | | | | | | | | | |
| Example | Methanol | 0.001 | — | — | — | — | — | 1 | 8.0% | 0.5% |
| 3-1 | | | | | | | | | | |
| Example | Methanol | 0.01 | — | — | — | — | 1.5 | — | 11% | 1.5% |
| 3-2 | | | | | | | | | | |
| Example | Methanol | 0.1 | — | — | — | 3 | — | — | 15% | 6.0% |
| 3-3 | | | | | | | | | | |
| Example | Methanol | 0.25 | — | — | 4 | — | — | — | 20% | 18% |
| 3-4-1 | | | | | | | | | | |
| Example | Methanol | 0.25 | — | — | 2 | — | — | — | 10% | 6.2% |
| 3-4-2 | | | | | | | | | | |
| Example | Methanol | 0.25 | — | 3 | — | — | — | — | 17% | 15% |
| 3-4-3 | | | | | | | | | | |
| Example | Methanol | 0.25 | — | 1.5 | — | — | — | — | 13% | 12% |
| 3-4-4 | | | | | | | | | | |
| Example | Methanol | 0.5 | — | 3 | — | — | — | — | 16% | 12% |
| 3-5 | | | | | | | | | | |
| Example | Methanol | 1.0 | 1 | — | — | — | — | — | 8.0% | 1.2% |
| 3-6 | | | | | | | | | | |
| Example | Ethanol | 0.001 | — | — | — | — | — | 1 | 2.0% | 0.5% |
| 4-1 | | | | | | | | | | |
| Example | Ethanol | 0.01 | — | — | — | — | 1.5 | — | 6.5% | 0.7% |
| 4-2 | | | | | | | | | | |
| Example | Ethanol | 0.1 | — | — | — | 3 | — | — | 12% | 1.8% |
| 4-3 | | | | | | | | | | |
| Example | Ethanol | 0.25 | — | — | 4 | — | — | — | 15% | 6.5% |
| 4-4 | | | | | | | | | | |
| Example | Ethanol | 0.5 | — | 3 | — | — | — | — | 20% | 12% |
| 4-5-1 | | | | | | | | | | |
| Example | Ethanol | 0.5 | — | 1.5 | — | — | — | — | 10% | 4.2% |
| 4-5-2 | | | | | | | | | | |
| Example | Ethanol | 0.5 | — | — | 4 | — | — | — | 9.5% | 8.5% |
| 4-5-3 | | | | | | | | | | |
| Example | Ethanol | 0.5 | — | — | 2 | — | — | — | 8.4% | 6.5% |
| 4-5-4 | | | | | | | | | | |
| Example | Ethanol | 1.0 | 1 | — | — | — | — | — | 11% | 8.5% |
| 4-6 | | | | | | | | | | |
| Example | Acetone | 0.001 | — | — | — | — | — | 1 | 1.0% | 0.2% |
| 5-1 | | | | | | | | | | |
| Example | Acetone | 0.01 | — | — | — | — | 1.5 | — | 1.5% | 0.5% |
| 5-2 | | | | | | | | | | |
| Example | Acetone | 0.1 | — | — | — | 3 | — | — | 5.0% | 6.5% |
| 5-3 | | | | | | | | | | |
| Example | Acetone | 0.25 | — | — | 4 | — | — | — | 12% | 10% |
| 5-4 | | | | | | | | | | |
| Example | Acetone | 0.5 | — | 3 | — | — | — | — | 35% | 15% |
| 5-5-1 | | | | | | | | | | |
| Example | Acetone | 0.5 | — | 1.5 | — | — | — | — | 12% | 6.5% |
| 5-5-2 | | | | | | | | | | |
| Example | Acetone | 0.5 | — | — | 4 | — | — | — | 22% | 8.5% |
| 5-5-3 | | | | | | | | | | |
| Example | Acetone | 0.5 | — | — | 2 | — | — | — | 10% | 3.5% |
| 5-5-4 | | | | | | | | | | |
| Example | Acetone | 1.0 | 1 | — | — | — | — | — | 7.5% | 2.5% |
| 5-6 | | | | | | | | | | |

According to the test results above, it can be observed that the nanofluid compositions of the disclosure, which include graphene nanoparticles with a weight ratio relative to the solvent of 1:100000 to 1:20 and a surfactant with a weight ratio relative to the graphene nanoparticles of 0.3:1 to 5:1, exhibit excellent heat dissipation performance.

By adding an appropriate surfactant, graphene can be more uniformly dispersed in the solvent, thereby improving the precipitation issue of the graphene nanofluids. The nanofluid composition of the disclosure achieves uniform dispersion of graphene in the solvent without easily precipitated by adding surfactant. The uniform dispersion can be maintained for at least 9 months, that is, no obvious layering is observed in any sample after 9 months of storage when examined with naked eyes. Such uniform dispersion facilitates maintaining the heat dissipation and cooling performance of the nanofluid composition.

In summary, the microwave plasma torch equipment provided by the disclosure can manufacture graphene nanoparticles with small and uniform sizes. In addition, the graphene nanoparticle fluid including graphene and surfactant of the disclosure has good heat dissipation performance and can maintain a uniformly suspended state for an extended period.

Although the disclosure has been disclosed through the aforementioned embodiments, they are not intended to limit the disclosure. Any modification and refinement made without departing from the spirit and scope of the disclosure fall within the scope of the patent protection for the disclosure. For the scope of protection defined by the disclosure, please refer to the appended claims.

What is claimed is:

1. A microwave plasma torch equipment, comprising:
a reaction chamber having:
a reaction area;
a microwave inlet;
a first divert channel and a second divert channel, each of the first divert channel and the second divert channel having a first end part and a second end part away from the first end part, wherein the first end parts are coupled to the microwave inlet, the second end parts are coupled to each other at the reaction area, cross-sectional areas of the first end parts are greater than cross-sectional areas of the second end parts; and
a microwave diverter, located at a junction of the microwave inlet, the first divert channel, and the second divert channel;
a ventilation tube, penetrating through the reaction area of the reaction chamber along a direction substantially perpendicular to an extending direction of the first divert channel and an extending direction of the second divert channel; and
a microwave source, located at the microwave inlet and facing the microwave diverter.

2. The microwave plasma torch equipment according to claim 1, further comprising a microwave guide having a first guiding surface and a second guiding surface, wherein the first guiding surface is a portion of the second end part of the first divert channel, and the second guiding surface is a portion of the second end part of the second divert channel.

3. The microwave plasma torch equipment according to claim 1, wherein the cross-sectional areas of the second end parts are greater than or equal to a cross-sectional area of the reaction area.

4. A method for manufacturing graphene nanoparticles with a microwave plasma torch equipment, comprising:
injecting an alkane gas and an inert gas into the microwave plasma torch equipment; and
heating the alkane gas from opposite sides of the alkane gas by two microwave plasmas propagating in opposite directions to obtain graphene nanoparticles.

5. A nanofluid composition, comprising: a solvent, graphene nanoparticles and a surfactant,
wherein a weight ratio of the graphene nanoparticles to the solvent is 1:100000 to 1:20; and
a weight ratio of the surfactant to the graphene nanoparticles is 0.3:1 to 5:1.

6. The nanofluid composition according to claim 5, wherein the solvent is water, methanol, ethanol, acetone or synthetic oil.

7. The nanofluid composition according to claim 5, wherein the surfactant comprises SDS, SDBS, Tween20-80, Span20-80, CTAB or TTAB.

8. A manufacturing method of a nanofluid composition, comprising:
obtaining graphene nanoparticles by using the method for manufacturing graphene nanoparticles with microwave plasma torch equipment according to claim 4;
adding the graphene nanoparticles and a surfactant into a solvent to form a mixture; and
stirring the mixture to make the graphene nanoparticles disperse uniformly in the solvent to form the nanofluid composition;
wherein a weight ratio of the graphene nanoparticles to the solvent is 1:100000 to 1:20; and
a weight ratio of the surfactant to the graphene nanoparticles is 0.3:1 to 5:1.

9. The manufacturing method of a nanofluid composition according to claim 8, wherein the step of stirring the mixture to make the graphene nanoparticles disperse uniformly in the solvent is performed by an ultrasonic oscillator.
